(19) United States
(12) Patent Application Publication
(10) Pub. No.: US 2016/0361891 A1
(43) Pub. Date: Dec. 15, 2016

(54) WATERPROOF BOARD AND ITS MANUFACTURING METHOD

(71) Applicant: ANHUI SENTAI WPC TEC FLOORING CO., LTD., Anhui (CN)

(72) Inventor: Daoyuan Tang, Anhui (CN)

(21) Appl. No.: 14/791,279

(22) Filed: Jul. 3, 2015

(30) Foreign Application Priority Data
Jun. 9, 2015 (CN) 2015103084200

(51) Int. Cl. B32B 3/30; B32B 37/12; B32B 21/08; B32B 27/30; B32B 27/08; B32B 7/12

(52) U.S. Cl. CPC B32B 3/30; B32B 27/08; B32B 7/12; B32B 21/08; B32B 27/304; B32B 37/1207; B32B 2307/7246; B32B 2307/54; B32B 2307/72; B32B 2264/067; B32B 2451/00; B32B 2419/04; B32B 2607/00; B32B 2272/00; B32B 2037/1215

(57) ABSTRACT

The present invention relates to a waterproof board and its manufacturing method, belongs to the technical field of floorboard and wallboards. The waterproof board includes waterproof layer and wear-resistant layer and the groove and ten on arranged on both side of said board respectively. Said wear-resistant layer is affixed onto said waterproof layer and said waterproof layer is made of the extrusion materials mainly including the resin and bamboo powder. The density of said waterproof layer is 0.60 kg/cm³-0.95 kg/cm³. The board of present invention is featured of high strength, good tensile strength, not easy to break; low water absorption rate, good waterproof performance; strong stability, less susceptible to deform due to changes in temperature or water immersion; light weight, more comfortable tactility, and further decreasing the material and transportation costs.

### CROSS-REFERENCE TO RELATED APPLICATIONS

This application claims priority to Chinese Patent Application No. 2015103084200 filed on Jun. 9, 2015, the contents of which are incorporated by reference herein.

### TECHNICAL FIELD

The invention relates to a floorboard and wallboard, in particular to a waterproof board and its manufacturing method.

### BACKGROUND

In general, the wooden or composite boards are adopted as the indoor flooring or wall pavement materials. Although the wooden board materials have a more comfortable tactility, it is easy to absorb water and deform due to drying, and the strength of wooden board is insufficient to resist the tilting and delamination; and although composite board extruded of sawdust mixed with binder features good appearance and low cost, it easily absorbs water and releases the formaldehyde that is not environmentally friendly. Therefore, in modern construction, such as in the LEED green buildings, it is required to further reduce the impact on the natural environment and to maximize the use of recycled materials or waste. Therefore, the utilization of wood plastic composite material board in floorboard, wallboard and other technical field becomes more and more important. The utility model patent CN203742125U discloses a wood-plastic flooring symmetrically arranged with a balance layer, including UV coating, PVC sheet layer, PVC decorative layer, upper balance layer, substrate layer and lower balance layer. The utility model adopts hard sheets as the upper and lower balance layers and uses the multilayer structure to solve the strength problem of wood-plastic board. But the multilayer structure makes the binding between the layers need more processing steps and add layers of adhesive, making the wood plastic floor has a poor stability, be easily delaminated by temperature changes or water immersion factors and not environmentally friendly. And its substrate layer uses the existing wood plastic composite material which has an ordinary waterproof effect.

### SUMMARY

Aiming at the shortages of the existing technology, the invention provides a kind of waterproof board with high strength, low water absorption rate, strong stability and environmental protection, and its manufacturing method.

In order to solve the above problems, the invention provides a technical scheme as follows: a waterproof board, comprising a waterproof layer and wear-resistant layer and the groove and tenon that are respectively arranged on both sides of the board. Said wear-resistant layer is affixed onto the waterproof layer and said waterproof layer is extruded via extrusion material with resin and bamboo-wood powder as main compositions. The density of said waterproof layer is 0.60 kg/cm³-0.95 kg/cm³.

The waterproof board has two layers of structure that is easy for processing. It uses the wear-resistant layer to improve the service life of the waterproof board and reach a certain static friction force to adapt to the tactility, and uses the waterproof layer formed of the wood plastic composite material to improve the waterproof performance of board. And the waterproof board is light in weight so that it has a comfortable foot feeling when it is used as the flooring and convenient transportation, and reduces the material and transportation costs in a certain extent.

As a preferred embodiment of the invention, said waterproof board can also comprise a decorative layer. Said wearing-resistant layer is hot-pressed onto said decorative layer and said decorative layer is affixed onto said waterproof layer. Alternatively, said waterproof board further comprises a bottom layer, said waterproof layer is affixed onto the bottom layer. Alternatively, said waterproof board also includes a decorative layer and a bottom layer. Said wear-resistant layer is hot-pressed onto the decorative layer, and said decorative layer is affixed onto said waterproof layer and said waterproof layer is affixed onto said bottom layer.

As a preferred embodiment of the invention, the extrusion materials used by said waterproof layer, include bamboo powder or wood powder or the mixture of both, accounting for 20%-40% of the total mass of extrusion materials; and the resin that accounts for 30%-40% of the total mass of extrusion materials.

As a preferred embodiment of the invention, the bamboo-wood powder refers to the bamboo powder, or the mixture of the bamboo powder and the wood powder, and said bamboo powder includes the tabasheer powder that accounts for at least 40% of the total mass of bamboo powder and the bamboo green powder that accounts for at most 60% of total mass of bamboo powder.

As a preferred embodiment of the invention, the particle size of resin and/or bamboo-wood powders in the waterproof layer ranges from 60 to 80 mesh.

As a preferred embodiment of the invention, the density of the waterproof layer further is 0.65 kg/cm³-0.75 kg/cm³.

As a preferred embodiment of the invention, the thickness of said waterproof layer is 3.8 mm-18.8 mm, and the tensile strength of said waterproof layer is 5.9 Mpa-12.5 Mpa.

As a preferred embodiment of the invention, the thickness of the wear layer is 0.085 mm-0.5 mm.

As a preferred embodiment of the invention, the static bending strength (MOR) of said waterproof layer is 21 Mpa-28 Mpa, and the elastic modulus (MOE) of said waterproof layer is 1490 Mpa-1580 Mpa.

The invention provides another technical scheme as follows: a waterproof board manufacturing method.

Step 1: Put the industrial waste with bamboo or wooden components into an extruder to obtain the bamboo-wood powder. Said bamboo-wood powder is bamboo powder or wood powder, or a mixture of both bamboo powder and wood powder. Said bamboo powder is mixed with said resin, wherein the bamboo powder shall be extruded for at least three times to finally make the bamboo-wood powder account for 20-40% of the total mass of extrusion materials, and the resin account for 30%-40% of the total mass of extrusion materials;

Step 2: The mixed bamboo-wood powder and resin added with additives are blended and modified in a blending machine, and then adding foaming agents into the machine. Said bamboo-wood powder, said resin, said additives and said foaming agents constitute the extrusion materials. The extrusion materials in the extruder are extruded into the waterproof layer via hot pressing under the temperature of 162 degrees C.-172 degrees C., and pressure of 20 Mpa-25 Mpa;

Step 3: The wear-resistant layer made of polyethylene or polyvinyl chloride is hot-pressed onto the decorative layer made of tile veneer or stone veneer or rubber veneer or decorative plastic veneer or linoleum veneer or decorative vinyl veneer under the temperature of 200 degrees C.-220 degrees C., and hot pressing pressure of 22-24 Mpa;

Step 4: Said decorative layer is affixed onto said waterproof layer under the temperature of at least 182 degrees C. by hot melt adhesive;

Step 5: Said waterproof layer is affixed onto said bottom layer at the temperature of 183 degrees C.-193 degrees C. by hot melt adhesive;

Step 6: Finish the tongue-and-groove processing and the Tu-edge processing of the waterproof board.

The waterproof board manufacturing method adopts the bamboo-wood powder and resin as the main compositions of the extruded material to form a waterproof layer with low density and good waterproof performance. The waterproof layer combines with the wear-resistant layer, decorative layer and the bottom layer together to form the main body of the board, making the board surface wear-resistant, beautiful, comfortable tactility. In this manufacturing method, a certain mass percentage of bamboo-wood powder and resin is added to form a waterproof board featured of low density and low bibulous rate and high strength, further improving the strength, stability and waterproof performance of the board.

The invention has the following beneficial effects:

(1) The waterproof board features simple structure and is easy to process and assemble.

(2) The waterproof layer uses a suitable weight of the wood powder or bamboo powder composition to mix with the resin to improve the wood plastic composite compatibility and is matched with the other layers, making better affinity and easy bonding between layer and layer. The entire waterproof board keeps consistent in the heat expansion and cold contraction. It has relatively high strength and stability, less susceptibility to deforming or delaminating due to the influences of temperature or water.

(3) It is light in weight, comfortable feeling under foot, and further reduces the cost of transportation and materials.

(4) The waterproof board is of great strength, tensile strength, and is not easy to break and deform.

(5) Environmentally friendly, passed the system certification of the FSC (Forest Stewardship Council).

### BRIEF DESCRIPTION OF THE DRAWINGS

FIG. 1 illustrates a perspective view of a waterproof board according to the first embodiment disclosed herein;

FIG. 2 illustrates a perspective view of a waterproof board according to the second embodiment disclosed herein;

FIG. 3 illustrates a perspective view of a waterproof board according to the third embodiment disclosed herein; and

FIG. 4 illustrates a perspective view of a waterproof board according to the third embodiment disclosed herein.

### DETAILED DESCRIPTION

In the Figures, the following numbers designate corresponding items:
1—wear-resistant layer; 2—decorative layer; 3—waterproof layer; 4—bottom layer; 5—groove; 6—tenon.

### Example 1

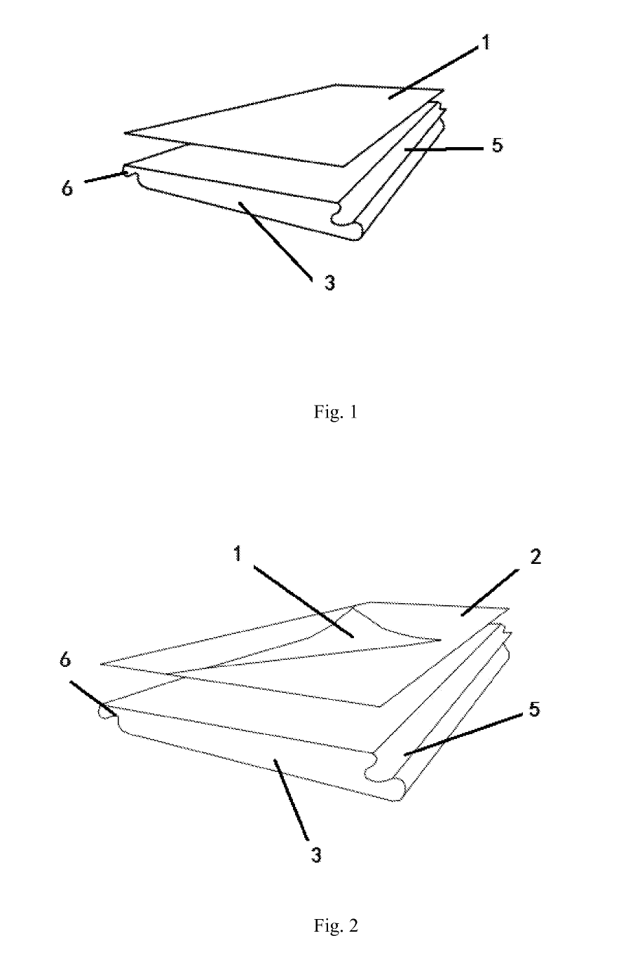

In FIG. 1, the waterproof board in this invention comprises: the wear-resistant layer 1, the waterproof layer 3, and groove 5 and tenon 6 respectively arranged on both sides of the board. Said wear-resistant layer 1 can be affixed onto the waterproof layer 3 via various bonding ways as hot melt adhesive. Profiles of said groove 5 and tenon 6 can be matched to form a fixation-connection between the adjacent boards. The fixation-connection can be mechanically clamping in a locking form or fastening with glue and other chemical methods.

The wear-resistant layer can be polyethylene or polyvinyl chloride material that features low absorption rate and good stability. When it is used as the surface of the waterproof board, it can exert the roles of waterproof, damp-proof and wear-resistant; and the wear-resistant layer has a certain friction, such as its static friction coefficient at least reaches to 0.62, it is conducive to slip-proof.

Said waterproof layer 3 contains the resin and the bamboo-wood powder. The polyvinyl chloride can be used as the resin. In the present invention, the bamboo-wood powder refers to a collective concept of the bamboo powder, or wood powder, or the mixture of bamboo powder or wood powder. Usually obtaining more environmentally friendly wood powder is not more convenient than obtaining the bamboo powder. The bamboo powder is easier in the extrusion molding than that of the wood powder; it is desirable to consider the use of the bamboo powder. The bamboo powder and wood powder that come from industrial waste materials can be recycled, are featured of low cost, and are beneficial to environmental protection.

In order to make the waterproof layer 3 have features of high strength, low water absorption rate and high stability, the extrusion materials in the waterproof layer 3, include the bamboo powder, or wood powder, or a mixture of both bamboo powder and wood powder accounting for 20%-40% of the total mass of the materials and the resin that accounts for 30%-40% of the total mass of the materials. Considering the board to be more environmentally friendly and with reduced cost in a certain extent, the larger percentage of the bamboo powder accounted for the total mass of extrusion materials can be better. Because of limited practical extrusion process currently available, it is almost impossible to increase the percentage of the bamboo powder material accounting for the total mass of extruded materials to 50%, especially above 55%. If we want to increase the bamboo-wood powder content above 40%, it can be realized through adding similar forming agents and other additives, or increasing the temperature or increasing extrusion pressure, but the finished product rate is low, as the resources are wasted, the difficulty of processing goes up significantly and the production efficiency is reduced accordingly. And if the bamboo-wood powder content is lower than 20%, it can reduce the bamboo powder molding process difficulty, but the waterproof layer is insufficiently environmentally friendly, high cost, and the waterproof layer stability is insufficient. Using said materials, the formaldehyde emission from the waterproof layer 3 is 0.15 mg/L-0.45 mg/L, reaching to the E0 level standard.

In general, bamboo includes bamboo green (bamboo outer skin) and tabasheer; the strength of bamboo green is higher than that of tabasheer. Considering the board strength, it is necessary to add more extruded powder of bamboo green and the bamboo green powder is difficult to mix with resin independently due to the wax on its surface, adequate amount of tabasheer extrusion powder shall be added. The optimized design is that the bamboo-wood powder is bamboo powder, or a mixture of both the bamboo powder and the wood powder. Said bamboo powder includes tabasheer powder accounted for at least 40% of total mass of bamboo powder, and the bamboo green powder accounted for at most 60% of the total mass of bamboo powder. This makes the waterproof layer have certain strength, and can use the wax of the bamboo green surface to lubricate, reduce the use of additional lubricant additives, and reduce formaldehyde emissions.

In order to further improve the strength of the waterproof layer 3, it is necessary to decrease the particle size. For example, the particle size of the resin or bamboo powder, or bamboo and wood powder and resin in the waterproof layer 3, ranges from 60-80 mesh. The larger size of the particles within the board the more difficult for the particles move within the board. It is easier to break or generate defects at the interface, and the small size of the particles can improve the tensile strength of the board, especially the strength of the waterproof layer. At the same time, with the decrease of particle size, it can further reduce the density of the waterproof layer, which enhances the strength of the board and makes the board lighter.

Said waterproof layer is filled with foaming agent. Before foaming, the density of said waterproof layer 3 is about 1.1 kg/cm³-1.3 kg/cm³. When adding baking soda etc. foaming agents, the density of the waterproof layer 3 decreases; the density of said waterproof layer is about 0.60 kg/cm³-0.95 kg/cm³. If coupled with the controls on the particle sizes of the bamboo-wood powder and/or resin in the waterproof layer, it can also further reduce the waterproof layer density, which makes the overall weight of board light to have a more comfortable feeling when it is used as a floor and further and further reduce the cost of materials and transportation. The density of the board can be further reduced to 0.65 kg/cm³-0.75 kg/cm³ or 0.60 kg/cm³-0.64 kg/cm³ or 0.70 kg/cm³-0.80 kg/cm³.

In order to protect the board against the easy abrasion, the thickness of the wear-resistant layer 1 is 0.085 mm-0.5 mm, further is 0.085 mm-0.15 mm, or 0.25 mm-0.35 mm. Besides the waterproof layer adopting the extrusion materials that are mainly composed of bamboo powder and the resin in said certain percentage to improve the strength and stability of the waterproof layer, the higher thickness of the waterproof layer 3 further improves the stability of waterproof board. The thickness of the waterproof layer 3 of the waterproof board is 3.8 mm-18.8 mm, the board is not easy to deform, and the stampede sound feeling is thicker and heavier. The thickness of the waterproof layer 3 can be further adjusted to 10.5 mm-12.5 mm, or 13.2 mm-15.2 mm, or 15.5 mm-18.8 mm. And the measured tensile strength of the waterproof layer is 5.9 Mpa-12.5 Mpa. That is to say, per square meter cross section of the waterproof layer can withstand 59000N-125000N; the waterproof layer is not easy to break and demonstrates a high tensile strength when it bears the stress within this range.

The static bending strength of the waterproof layer 3 is 21 Mpa-28 Mpa, and the elastic modulus of the waterproof layer 3 is 1490 Mpa-1580 Mpa. The static bending strength is the ratio of the bending moment and the modulus of bending section when the maximum load is acting, and the larger the numerical value is, the stronger the bending resistance is. Said parameters mean that the internal bonding strength of the waterproof layer 3 has been improved and its water absorption rate has been decreased. Within static bending strength and elastic modulus range, the binding force between cellulose molecules has been reduced, the external resistance increases, making it difficult deform the waterproof layer.

The wood-plastic compatibility of the waterproof layer made of the extrusion materials has been improved after appropriate mass percentage of mixed bamboo-wood powder and resin is achieved, so that the waterproof layer features lower water absorption rate, stable thermal expansion and cold contraction, high strength, low density, and not easy to deform or delaminate due to changes in temperature and soaking factors. The size expansion of the waterproof layer exposed to the wet environment is not more than 0.0099%. At the same time, the waterproof board of this design is of low cost, environmentally friendly, and suitable for the United States LEED green building.

Said waterproof board also includes additives. The additives can contain stone powder and talcum powder. The content of the stone powder and talcum powder accounts for less than 40% of the total mass of the extrusion materials. If coloring, mildew proof, lubrication and other effects are considered, the additives can also contain anti UV agent, antioxidant, stabilizer, coloring agent, anti-mildew agent, coupling agent, reinforcing agent and lubricant.

The manufacturing process of the waterproof board: Step 1: Put the industrial waste containing the bamboo or wood components in the extruder to obtain the bamboo-wood powder, which is the bamboo powder, or wood powder or a mixture of both. The bamboo-wood powder is mixed with the resin; in general, it is more difficult for the bamboo powder extrusion than that of the wood powder. During the extrusion process, one-step extrusion cannot be achieved and multiple extrusions are required. Each time, the bamboo powder accounting for at most 5%-8% of the total mass of the extrusion materials can be extruded. The first 7% of the bamboo powder extruded is mixed with the resin, and another 7% of bamboo powder is added in the second time. It roughly needs 6 times for you to reach the required 40% of bamboo-wood powder. When 8% of the bamboo powder is extruded each time, you need to extrude 3 times to reach 20% of the bamboo-wood powder required. So, at least 3 times for bamboo power extrusion is required, making the final mass of the bamboo-wood powder account for 20%-40% of the total mass of the extrusion materials, and the resin account for 30%-40% of the total mass of the extrusion materials.

Step 2: Said mixture of the bamboo-wood powder and resin added with additives such as the stone powder and talcum powder are blended and modified in a blending machine, and then adding the foaming agent into the machine. Said bamboo-wood powder, said resin, said additives and said foaming agents constitute the extrusion materials. Said foaming agents can be soda or calcium bicarbonate. The extrusion materials in the extruder are extruded into the waterproof layer via hot pressing under the temperature of 162 degrees C.-172 degrees C., and pressure of 20 Mpa-25 Mpa. The gas evaporates after foaming, the volume of the waterproof layer gets larger and its thickness is about 3.8 mm-18.8 mm, while its density is minimized to about 0.60 kg/cm3-0.95 kg/cm³. In order to improve the forming rate of the waterproof board, especially the forming rate after adding the bamboo powder, the forming agent additives shall be added, or the processing temperature and extrusion pressure etc. shall be increased. With the increment of the process temperature, the water-swelling rate of the waterproof layer is decreased, and the internal bonding strength of the waterproof layer is improved. The static bending strength and the elastic modulus are improved, and the waterproof layer is stable and not easy to deform.

Step 3: The wear-resistant layer made of polyethylene or polyvinyl chloride is affixed onto the waterproof layer by hot melt adhesive at the temperature of at least 182 degrees C., where the upper surface of said wear-resistant layer is coated with wax or paint, the thickness of the wear-resistant layer is 0.085 mm-0.5 mm;

Step 4: Finish the tongue-and-groove processing and the Tu-edge processing of the waterproof board, i.e. setting the grooves 5 and tenons 6 on both sides of the waterproof board respectively.

The waterproof board is made according to the waterproof board manufacturing method. The following examples 2, 3 and 4, have the wear-resistant layer 1 and waterproof layer 3 made of same materials, and the groove 5 and tenon 6 that have the same structure of that in Example 1.

### Example 2

As shown in FIG. 2, the waterproof board in this invention comprises: the wear-resistant layer 1, the decorative layer 2, the waterproof layer 3, and the groove 5 and the tenon 6 respectively arranged on both sides of the board. Said decorative layer 2 is set between the wear-resistant layer 1 and the waterproof layer 3, the wear-resistant layer 1 and said decorative layer 2 are hot-pressed into one, and then affixed onto said waterproof layer 3 via bonding ways like hot melt adhesive. Said decorative layer 2 can be the tile veneer or stone veneer or rubber veneer or decorative plastic veneer or linoleum veneer or decorative vinyl veneer, which is not only beautiful but also waterproof. The profiles of groove 5 and tenon 6 can be matched to form a fixation-connection between the adjacent boards. The fixation-connection can be mechanically clamping in a locking form or fastening with glue and other chemical methods.

The manufacturing process of the waterproof board: Step 1: Put the industrial waste containing the bamboo or wood components in the extruder to obtain the bamboo-wood powder, which is the bamboo powder, or wood powder or a mixture of both. The bamboo-wood powder is mixed with the resin. In general, it is more difficult for the bamboo powder extrusion than that of the wood powder. During the extrusion process, the bamboo powders cannot be extruded in one step and multiple extrusions are required. For example, each time the bamboo powder accounting for at most 5%-8% of the total mass of the extrusion materials can be extruded, the first 7% of the bamboo powder extruded is mixed with the resin, and another 7% of bamboo powder is added in the second time. It roughly needs 6 times for you to reach the required 40% of bamboo-wood powder. When 8% of the bamboo powder is extruded each time, you need to extrude 3 times to reach 20% of the bamboo-wood powder required. So, at least 3 times for bamboo power extrusion is required, making the final mass of the bamboo-wood powder account for 20%-40% of the total mass of the extrusion materials and the resin account for 30%-40% of the total mass of the extrusion materials.

Step 2: Said mixture of the bamboo-wood powder and resin added with additives such as the stone powder and talcum powder can be blended and modified in a blending machine, and then adding the foaming agent into the machine. Said bamboo-wood powder, said resin, said additives and said foaming agents constitute the extrusion materials. Said foaming agents can be soda or calcium bicarbonate. The extrusion materials in the extruder are extruded into the waterproof layer via hot pressing under the temperature of 162 degrees C.-172 degrees C., and pressure of 20 Mpa-25 Mpa. The gas evaporates after foaming; the volume of the waterproof layer gets larger and its thickness is about 3.8 mm-18.8 mm, while its density is minimized to about 0.60 kg/cm³-0.95 kg/cm³. In order to improve the forming rate of the waterproof board, especially the forming rate after adding the bamboo powder, the forming agent additives shall be added, or the processing temperature and extrusion pressure etc. shall be increased. With the increment of the process temperature, the water-swelling rate of the waterproof layer is decreased, and the internal bonding strength of the waterproof layer is improved, the static bending strength and the elastic modulus are improved, and the waterproof layer is stable and not easy to deform.

Step 3: the wear-resistant layer made of polyethylene or polyvinyl chloride is affixed onto the decorative layer made of the tile veneer or stone veneer or rubber veneer or decorative plastic veneer or linoleum veneer or decorative vinyl veneer by hot melt adhesive at the temperature of 200-220 degrees C., the pressure of 22-24 Mpa. The upper surface of said wear-resistant layer is coated with wax or paint, the thickness of the wear-resistant layer is 0.085 mm-0.5 mm; the thickness of the decorative layer is 0.02 mm-0.08 mm.

Step 4: Said decorative layer is affixed onto the waterproof layer by hot melt adhesive at the temperature of at least 182 degrees C.

Step 5: Finish the tongue-and-groove processing and the Tu-edge processing of the waterproof board, i.e. setting the grooves 5 and tenons 6 on both sides of the waterproof board respectively.

### Example 3

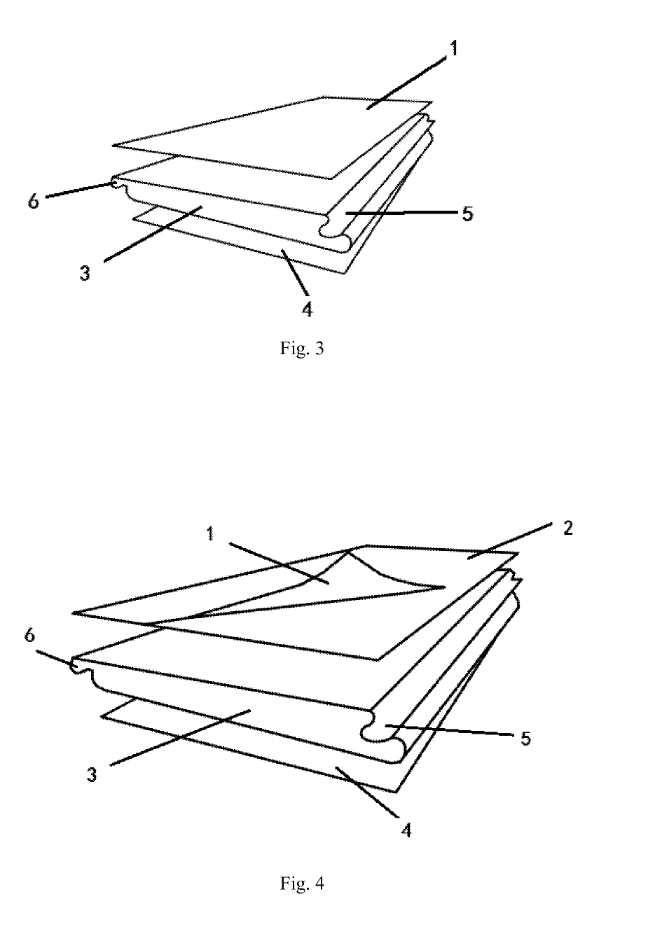

As shown in FIG. 3, the waterproof board in this invention comprises: the wear-resistant layer 1, the waterproof layer 3, bottom layer 4 and groove 5 and tenon 6 respectively arranged on both sides of the board. Said waterproof layer 3 is set between the wear-resistant layer 1 and the bottom layer 4. The wear-resistant layer 1 is affixed onto the waterproof layer 3 by bonding ways like hot melt adhesive, and said waterproof layer 3 is affixed onto said bottom layer 4 via bonding ways as hot melt adhesive. Said decorative layer 2 can be the tile veneer or stone veneer or rubber veneer or decorative plastic veneer or linoleum veneer or decorative vinyl veneer, which is not only beautiful but also waterproof. Said bottom layer 4 can be soft wood or rubber materials. The profile of groove 5 and tenon 6 can be matched to form a fixation-connection between the adjacent boards. The fixation-connection can be mechanically clamping in a locking form or fastening with glue and other chemical methods.

The manufacturing process of the waterproof board: Step 1: Put the industrial waste containing the bamboo or wood components in the extruder to obtain the bamboo-wood powder, which is the bamboo powder, or wood powder or a mixture of both; the bamboo-wood powder is mixed with the resin. In general, it is more difficult for the bamboo powder extrusion than that of the wood powder. During the extrusion process, the bamboo powder cannot be extruded in one step and multiple extrusions are required. Each time the bamboo powder accounting for at most 5%-8% of the total mass of the extrusion materials can be extruded. The first 7% of the bamboo powder extruded is mixed with the resin, and another 7% of bamboo powder is added in the second time. It roughly needs 6 times for you to reach the required 40% of bamboo-wood powder. When 8% of the bamboo powder is extruded each time, you need to extrude at 3 times to reach 20% of the bamboo-wood powder required. So, at least 3 times for bamboo power extrusion is required, making the final mass of the bamboo-wood powder account for 20%-40% of the total mass of the extrusion materials and the resin account for 30%-40% of the total mass of the extrusion materials.

Step 2: Said mixture of the bamboo-wood powder and resin added with additives such as the stone powder and talcum powder can be blended and modified in a blending machine, and then adding the foaming agent into the machine. Said bamboo-wood powder, said resin, said additives and said foaming agents constitute the extrusion materials. Said foaming agents can be soda or calcium bicarbonate. The extrusion materials in the extruder are extruded into the waterproof layer via hot pressing under the temperature of 162 degrees C.-172 degrees C., and pressure of 20 Mpa-25 Mpa. The gas evaporates after foaming, the volume of the waterproof layer gets larger and its thickness is about 3.8 mm-18.8 mm, while its density is minimized to about 0.60 kg/cm³-0.95 kg/cm³. In order to improve the forming rate of the waterproof board, especially the forming rate after adding the bamboo powder, the forming agent additives shall be added, or the processing temperature and extrusion pressure etc. shall be increased. With the increment of the process temperature, the water-swelling rate of the waterproof layer is decreased, and the internal bonding strength of the waterproof layer is improved, the static bending strength and the elastic modulus are improved, and the waterproof layer is stable and not easy to deform.

Step 3: the wear-resistant layer made of polyethylene or polyvinyl chloride is affixed onto the waterproof layer at the temperature of at least 182 degrees C. via hot melt adhesive. The upper surface of said wear-resistant layer is coated with wax or paint. The thickness of the wear-resistant layer is 0.085 mm-0.5 mm.

Step 4: Said waterproof layer is affixed onto the bottom layer by hot melt adhesive at a temperature of 183-193 degrees C. The thickness of said bottom layer is 1.2 mm-2.6 mm.

Step 5: Finish the tongue-and-groove processing and the Tu-edge processing of the waterproof board, i.e. setting the grooves 5 and tenons 6 on both sides of the waterproof board respectively.

### Example 4

As shown in FIG. 4, this invention comprises: the wear-resistant layer 1, the decorative layer 2, the waterproof layer 3, the bottom layer 4, and the groove 5 and the tenon 6 arranged respectively on both sides of the board. Said decorative layer 2 is set between the wear-resistant layer 1 and the waterproof layer 3, and said bottom layer 4 is set under the waterproof layer 3. Said wear-resistant layer 1 and said decorative layer 2 are pressed into one via hot pressing, and then affixed onto said waterproof layer 3 via bonding ways like hot melt adhesive. Said wear-resistant layer 1, said decorative layer 2 and said waterproof layer 3 bonded together into one part, which is affixed onto the bottom layer 4 via bonding ways like hot melt adhesive. Said decorative layer 2 can be the tile veneer or stone veneer or rubber veneer or decorative plastic veneer or linoleum veneer or decorative vinyl veneer, which is not only beautiful but also waterproof. Said bottom layer 4 can be soft wood or rubber materials. The profile of groove 5 and tenon 6 can be matched to form a fixation-connection between the adjacent boards. The fixation-connection can be mechanically clamping in a locking form or fastening with glue and other chemical methods.

The manufacturing process of the waterproof board: Step 1: Put the industrial waste containing the bamboo or wood components in the extruder to obtain the bamboo-wood powder, which is the bamboo powder, or wood powder or a mixture of both; the bamboo-wood powder is mixed with the resin. In general, it is more difficult for the bamboo powder extrusion than that of the wood powder. During the extrusion process, the bamboo powder cannot be extruded in one step and multiple extrusions are required. Each time the bamboo powder accounting for at most 5%-8% of the total mass of the extrusion materials can be extruded. The first 7% of the bamboo powder extruded is mixed with the resin, and another 7% of bamboo powder is added in the second time. It roughly needs 6 times for you to reach the required 40% of bamboo-wood powder; when 8% of the bamboo powder is extruded each time. You need to extrude 3 times to reach 20% of the bamboo-wood powder required. So, at least 3 times for bamboo power extrusion is required, making the final mass of the bamboo-wood powder account for 20%-40% of the total mass of the extrusion materials and the resin account for 30%-40% of the total mass of the extrusion materials.

Step 2: Said mixture of the bamboo-wood powder and resin added with additives such as the stone powder and talcum powder can be blended and modified in a blending machine, and then adding the foaming agents into the machine. Said bamboo-wood powder, said resin, said additives and said foaming agents constitute the extrusion materials. Said foaming agents can be soda or calcium bicarbonate. The extrusion materials in the extruder are extruded into the waterproof layer via hot pressing under the temperature of 162 degrees C.-172 degrees C., and pressure of 20 Mpa-25 Mpa. The gas evaporates after foaming, the volume of the waterproof layer gets larger and its thickness is about 3.8 mm-18.8 mm, while its density is minimized to about 0.60 kg/cm³-0.95 kg/cm³. In order to improve the forming rate of the waterproof board, especially the forming rate after adding the bamboo powder, the forming agent additives shall be added, or the processing temperature and extrusion pressure etc. shall be increased. With the increment of the process temperature, the water-swelling rate of the waterproof layer is decreased, and the internal bonding strength of the waterproof layer is improved, the static bending strength and the elastic modulus are improved, and the waterproof layer is stable and not easy to deform.

Step 3: The wear-resistant layer made of polyethylene or polyvinyl chloride is hot-pressed onto the decorative layer made of the tile veneer or stone veneer or rubber veneer or decorative plastic veneer or linoleum veneer or decorative vinyl veneer at the temperature of 200-220 degrees C., the pressure of 22-24 Mpa. The upper surface of said wear-resistant layer is coated with wax or paint. The thickness of the wear-resistant layer is 0.085 mm-0.5 mm and the thickness of the decorative layer is 0.02 mm-0.08 mm.

Step 4: Said decorative layer is affixed onto the waterproof layer by hot melt adhesive at a temperature of at least 182 degrees C.

Step 5: Said waterproof layer is affixed onto the bottom layer by hot melt adhesive at a temperature of 183-193 degrees C. The thickness of said bottom layer is 1.2 mm-2.6 mm.

Step 6: Finish the tongue-and-groove processing and the Tu-edge processing of the waterproof board, i.e. setting the groove 5 and tenon 6 on both sides of the waterproof board respectively.

The examples described above are only a description of the preferred embodiments of the invention, and not limited to the conception and scope of the invention. Under the premise of not separating from the conception design of the invention, various variants and refinements made on technical scheme of the invention by the general staff of the field, shall be in the scope of protection of the invention, the technology contents requesting protection in the invention, have all recorded in the claims.

What is claim is:

1. A waterproof board, characterized in that including a waterproof layer, a wear-resistant layer, and a groove and a tenon that are respectively arranged on both sides of the board; said wear-resistant layer is affixed onto said waterproof layer; said waterproof layer is extruded via extrusion material with resin and bamboo-wood powder as main compositions; the density of said waterproof layer is between 0.60 kg/cm³ and 0.95 kg/cm³.

2. The waterproof board of claim 1, wherein the waterproof board also comprises a decorative layer, and said wear-resistant layer is hot-pressed onto the decorative layer, and said decorative layer is affixed onto the waterproof layer.

3. The waterproof board of claim 1, wherein the waterproof board also comprises a bottom layer, and said waterproof layer is affixed onto the bottom layer.

4. The waterproof board of claim 1, wherein the waterproof board also comprises a decorative layer and bottom layer; said wear-resistant layer is hot-pressed onto the decorative layer, and the decorative layer is affixed onto said waterproof layer, and said waterproof layer is affixed onto the bottom layer.

5. The waterproof board of claim 1, wherein the extrusion materials of said waterproof layer are, bamboo powder or wood powder or a mixture of both, accounting for between 20% and 40% of the total mass of materials, and resin accounting for between 30% and 40% of the total mass of materials.

6. The waterproof board of claim 5, wherein the bamboo-wood powder is the bamboo powder, or a mixture of bamboo powder and wood powder; Said bamboo powder includes the tabasheer powder that accounts for at least 40% of the total mass of bamboo powder and the bamboo green powder that accounts for at most 60% of total mass of bamboo powder.

7. The waterproof board of claim 1, wherein the particle size of the resin and/or bamboo-wood powder of said waterproof layer ranges from between 60 and 80 mesh.

8. The waterproof board of claim 1, wherein the density of the waterproof layer further is between 0.65 kg/cm³ and 0.75 kg/cm³.

9. The waterproof board of claim 1, wherein the thickness of the waterproof layer is between 3.8 mm and 18.8 mm, and the tensile strength of the waterproof layer is between 5.9 Mpa and 12.5 Mpa.

10. The waterproof board of claim 5, wherein the thickness of the waterproof layer is between 3.8 mm and 18.8 mm, and the tensile strength of the waterproof layer is between 5.9 Mpa and 12.5 Mpa.

11. The waterproof board of claim 1, wherein the thickness of the wear layer is between 0.085 mm and 0.5 mm.

12. The waterproof board of claim 1, wherein the static bending strength of the waterproof layer is between 21 Mpa and 28 Mpa, and the elastic modulus of the waterproof layer is between 1490 Mpa and 1580 Mpa.

13. The waterproof board of claim 5, wherein the static bending strength of the waterproof layer is between 21 Mpa and 28 Mpa, and the elastic modulus of the waterproof layer is between 1490 Mpa and 1580 Mpa.

14. A waterproof board manufacturing method, comprising:
providing the industrial waste containing the bamboo or wood components in a extruder to obtain the bamboo-wood powder, which is formed from bamboo powder, wood powder, or a mixture of both; the bamboo-wood powder is mixed with the resin, wherein the bamboo is extruded at least 3 times, finally making the mass of the bamboo-wood powder account for between 20% and 40% of the total mass of extrusion materials for use in the extruder, and the resin account for between 30% and 40% of the total mass of the extrusion materials;
wherein the mixture of the bamboo-wood powder, wherein the resin includes additives, and the resin added with additives are blended and modified in a blending machine, and foaming agents are added into the blending machine;
wherein the bamboo-wood powder, resin, additives and said foaming agents constitute the extrusion materials;
wherein the extrusion materials in the extruder are extruded into the waterproof layer via hot pressing under the temperature of 162 degrees C.-172 degrees C., and pressure of 20 Mpa-25 Mpa;
wherein the wear-resistant layer is made of polyethylene or polyvinyl chloride and is affixed onto a decorative layer made of one of tile veneer, stone veneer, rubber veneer, decorative plastic veneer, linoleum veneer, or decorative vinyl veneer by a hot melt adhesive at the temperature of 200 degrees C. and 220 degrees C. and at a pressure of between 22 MPa and 24 MPa;
the decorative layer is affixed onto the waterproof layer by hot melt adhesive at a temperature of at least 182 degrees C.;
the waterproof layer is affixed onto the bottom layer by hot melt adhesive at a temperature of between 183 degrees C. and 193 degrees C.;
the method including finish the board with a tongue-and-groove processing and a Tu-edge processing.
